(19) United States
(12) Patent Application Publication
(10) Pub. No.: US 2023/0205176 A1
(43) Pub. Date: Jun. 29, 2023

(54) MANAGEMENT SYSTEM, MODELING MANAGEMENT SYSTEM, MANAGEMENT METHOD, AND COMPUTER-READABLE MEDIUM

(71) Applicant: Hidenori SHINDOH, Tokyo (JP)

(72) Inventor: Hidenori SHINDOH, Tokyo (JP)

(21) Appl. No.: 18/118,140

(22) Filed: Mar. 7, 2023

Related U.S. Application Data
(63) Continuation of application No. PCT/JP2021/041184, filed on Nov. 9, 2021.

(30) Foreign Application Priority Data
Nov. 27, 2020 (JP) 2020-197173

(51) Int. Cl. G05B 19/4099

(52) U.S. Cl. CPC G05B 19/4099; G05B 2219/49007

(57) ABSTRACT

A management system is configured to manage an apparatus configured to perform a modeling process for generating three-dimensional modeled object. The management system includes an apparatus data acquiring unit, and a state determining unit. The apparatus data acquiring unit is configured to acquire apparatus data on an operation of the apparatus. The state determining unit is configured to determine a state of the apparatus, using the acquired apparatus data and reference data corresponding to a reference state of the apparatus to be managed.

### CROSS-REFERENCE TO RELATED APPLICATIONS

The present application is a continuation application of International Application No. PCT/JP2021/041184, filed Nov. 9, 2021, which claims priority to Japanese Patent Application No. 2020-197173, filed Nov. 27, 2020. The contents of these applications are incorporated herein by reference in their entirety.

### BACKGROUND OF THE INVENTION

### 1. Field of the Invention

The present disclosure relates to a management system, a modeling management system, a management method, and a computer-readable medium.

### 2. Description of the Related Art

In recent years, a modeling system using an apparatus, such as a three-dimensional modeling apparatus, is known (for example, Japanese Translation of PCT International Application Publication No. 2019-514744) as a system that generates a three-dimensional modeled object without using a mold.

In a modeling process for a three-dimensional modeled object, it is necessary to use apparatuses for different purposes to perform processes, such as modeling, sintering, or post-processing including coating, in order to obtain a three-dimensional modeled object as a finished product. Therefore, a person who manages a modeling system has a need to centrally manage states of the apparatuses involved in the modeling process in order to smoothly perform the modeling process.

However, in a conventional method, specifications, functions, or the like of apparatuses vary depending on the apparatuses included in the modeling system, and therefore, there is a problem in that it is difficult to manage the states of the apparatuses involved in the modeling process independently of the apparatuses included in the modeling process.

### SUMMARY OF THE INVENTION

According to an aspect of the present invention, a management system is configured to manage an apparatus configured to perform a modeling process for generating three-dimensional modeled object. The management system includes an apparatus data acquiring unit, and a state determining unit. The apparatus data acquiring unit is configured to acquire apparatus data on an operation of the apparatus. The state determining unit is configured to determine a state of the apparatus, using the acquired apparatus data and reference data corresponding to a reference state of the apparatus to be managed.

### BRIEF DESCRIPTION OF THE DRAWINGS

FIG. 1 is a diagram illustrating an example of an entire configuration of a modeling management system;

FIG. 2 is a diagram illustrating an example of a configuration of a modeling system;

FIG. 3 is a diagram illustrating another example of the configuration of the modeling system;

FIG. 4 is a diagram illustrating an example of a hardware configuration of a management apparatus and a communication terminal;

FIG. 5 is a diagram illustrating an example of a hardware configuration of a control device;

FIG. 6 is a diagram illustrating an example of a functional configuration of the management apparatus;

FIG. 7 is a schematic diagram illustrating an example of a system management table;

FIG. 8 is a schematic diagram illustrating an example of an apparatus management table;

FIG. 9 is a schematic diagram illustrating an example of a process management table;

FIG. 10 is a schematic diagram illustrating an example of a process state management table;

FIG. 11 is a schematic diagram illustrating an example of an apparatus data management table;

FIG. 12 is a diagram illustrating an example of a functional configuration of the modeling management system;

FIG. 13 is a schematic diagram illustrating an example of a condition information management table;

FIG. 14 is a sequence diagram illustrating an example of a modeling process determination process in the management apparatus;

FIG. 15 is a sequence diagram illustrating an example of an apparatus state management process in the modeling management system;

FIG. 16 is a flowchart illustrating an example of an apparatus state monitoring process;

FIG. 17A is a diagram for explaining an example of apparatus data;

FIG. 17B is a diagram for explaining an example of apparatus data;

FIG. 17C is a diagram for explaining an example of apparatus data;

FIG. 17D is a diagram for explaining an example of apparatus data;

FIG. 17E is a diagram for explaining an example of apparatus data;

FIG. 18 is a diagram for schematically explaining an example of apparatus states determination process;

FIG. 19 is a sequence diagram illustrating an example of the apparatus state management process in the modeling management system;

FIG. 20 is a diagram illustrating a functional configuration of a management apparatus according to a modification;

FIG. 21 is a sequence diagram illustrating an apparatus state management process in a modeling management system according to the modification; and

FIG. 22 is a sequence diagram illustrating the apparatus state management process in the modeling management system according to the modification.

The accompanying drawings are intended to depict exemplary embodiments of the present invention and should not be interpreted to limit the scope thereof. Identical or similar reference numerals designate identical or similar components throughout the various drawings.

### DETAILED DESCRIPTION OF THE PREFERRED EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

Embodiments of the present invention will be described below with reference to the drawings. In the description of the drawings below, the same components are denoted by the same reference symbols, and repeated explanation will be omitted.

### Embodiment

Overview of Modeling Management System

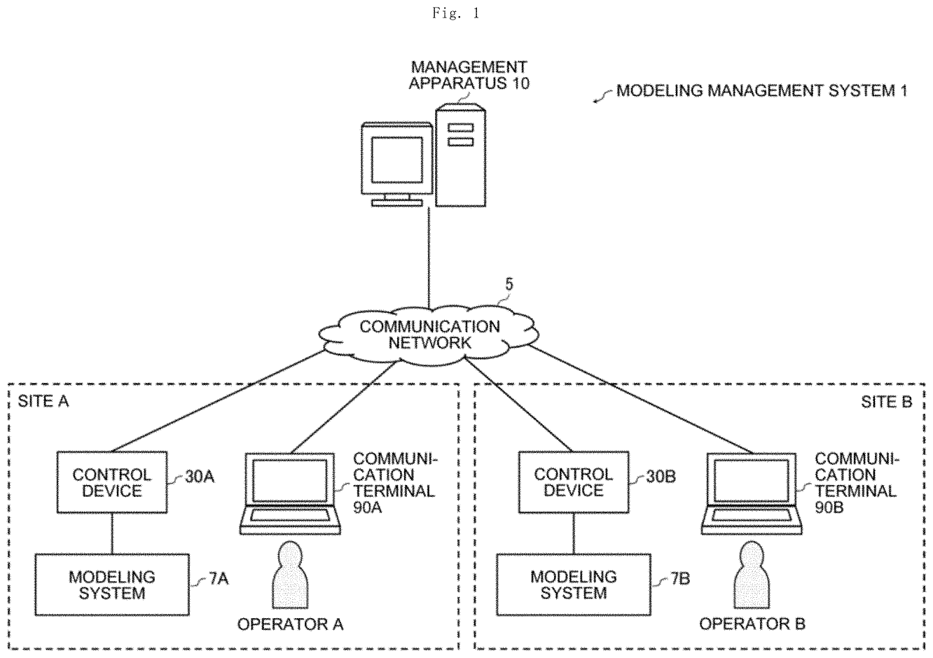

An overview of a modeling management system according to one embodiment will be described below with reference to FIG. 1. FIG. 1 is a diagram illustrating an example of an entire configuration of the modeling management system. A modeling management system 1 illustrated in FIG. 1 is a system that is able to centrally manage states of modeling systems 7 that perform processes of generating three-dimensional modeled objects.

As illustrated in FIG. 1, the modeling management system 1 includes a management apparatus 10 and includes the modeling systems 7 (7A and 7B), control devices 30 (30A and 30B), and communication terminals 90 (90A and 90B) that are located at a plurality of sites (a site A and a site B). The management apparatus 10, the control devices 30, and the communication terminals 90 included in the modeling management system 1 are able to communicate with one another via a communication network 5. The communication network 5 is constructed by the Internet, a mobile communication network, a local area network (LAN), or the like. The communication network 5 may include not only a network using wired communication, but also a network using wireless communication, such as 3rd Generation (3G), 4th Generation (4G), 5th Generation (5G), Wireless Fidelity (Wi-Fi) (registered trademark), Worldwide Interoperability for Microwave Access (WiMAX), or Long Term Evolution (LTE).

The management apparatus 10 is a server computer for managing information on the modeling system 7 at each of the sites. As illustrated in FIG. 1, the plurality of modeling systems 7 are present under control of the management apparatus 10, and the management apparatus 10 centrally manages operating states of the respective modeling systems 7. The management apparatus 10 may be configured with a single server computer, or may be configured with a plurality of server computers.

The modeling system 7 is a system that includes a plurality of apparatuses for generating a three-dimensional modeled object. Further, the control device 30 is connected to each of the modeling systems 7. The control device 30 is an edge device that controls the apparatuses included in the modeling system 7. For example, the control device 30 reads operation of a connected apparatus or a change in the connected apparatus. Here, the operation of the apparatus includes a state in which the apparatus is operating and a state in which the apparatus is not operating.

While FIG. 1 illustrates an example in which the management apparatus 10 manages the modeling systems 7 at the two sites (the site A and the site B), the modeling management system 1 may be configured such that the management apparatus 10 manages the modeling system 7 at a single site or the modeling systems 7 at three or more sites. Further, the modeling management system 1 may include the plurality of modeling systems 7 at a single site. Here, the management apparatus 10 and the control devices 30 constitute a management system that manages the modeling systems 7 that perform modeling processes for generating three-dimensional modeled objects, and apparatuses that are involved in the modeling processes.

The communication terminal 90 is a computer, such as a notebook personal computer (PC), used by an operator who performs a modeling process at each of the sites. The communication terminal 90 analyzes and converts three-dimensional (3D) data by using an application program, and generates modeling data for generating a three-dimensional object. The communication terminal 90 is not limited to a notebook PC, but may be, for example, a smartphone, a tablet terminal, a wearable terminal, or the like.

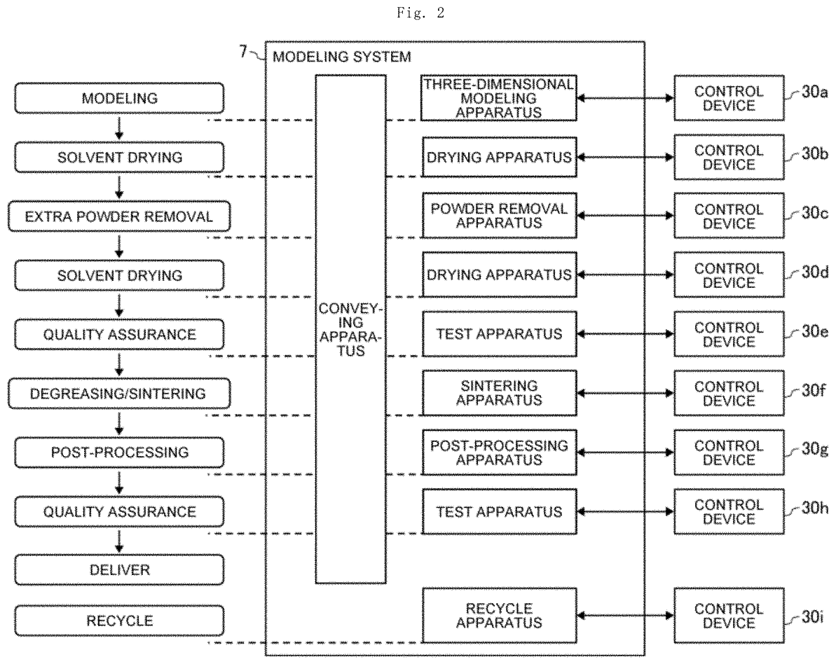

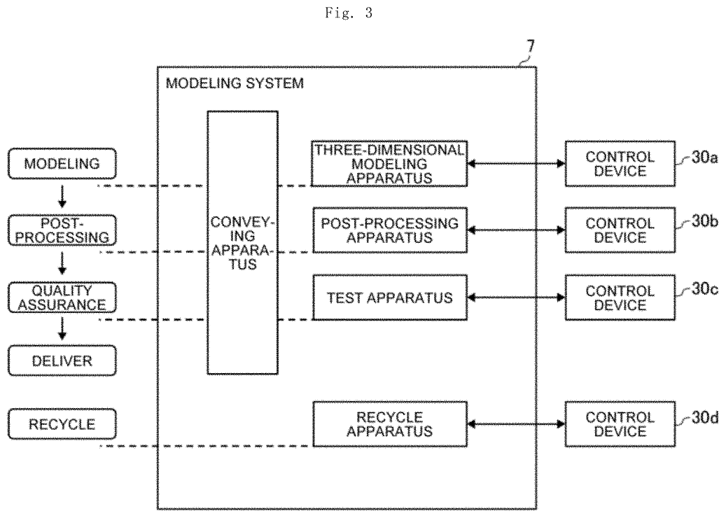

A configuration of the modeling system 7 will be described below with reference to FIGS. 2 and 3. FIGS. 2 and 3 are diagrams illustrating examples of the configuration of the modeling system. The modeling system 7 includes a plurality of apparatuses that are used for different purposes, and generates a three-dimensional modeled object by performing processes included in the modeling process by using the corresponding apparatuses. Here, the three-dimensional modeled object is a modeled object as a finished product in the modeling process performed by the modeling system 7.

The modeling system 7 illustrated in FIG. 2 includes a three-dimensional modeling apparatus, a drying apparatus, a powder removal apparatus, a test apparatus, a sintering apparatus, a post-processing apparatus, a test apparatus, a conveying apparatus, and a recycle apparatus. The apparatuses included in the modeling system 7 are examples of apparatuses used to generate a three-dimensional modeled object. FIG. 2 illustrates an example of a modeling system that generates a three-dimensional modeled object by using a binder jetting method (powder deposition modeling method).

In the example in FIG. 2, the three-dimensional modeling apparatus is, for example, a powder (fine particle) modeling apparatus, and performs a modeling process for a laminated body using powder (fine particle). The three-dimensional modeling apparatus repeats, as the modeling process, a process of forming a powder layer through powder supplying and flattening and a process of ejecting a modeling liquid to the powder layer the necessary number of times, and forms a laminated body that is formed by depositing a new powder layer on another powder layer. The laminated body serves as a target object that is processed by the three-dimensional modeling apparatus.

Further, the modeling system 7 illustrated in FIG. 2 performs a solvent drying process using the drying apparatus with respect to the target object (laminated body) that is processed by the three-dimensional modeling apparatus. Then, the modeling system 7 removes extra powder from the laminated body by the powder removal apparatus, and performs the solvent drying process again by the drying apparatus again.

Subsequently, the modeling system 7 performs a quality assurance test using the test apparatus, and thereafter performs a decreasing and sintering process using the sintering apparatus. In the decreasing and sintering process, for example, a green part that is made of pure aluminum or an aluminum alloy material is heated at resin decomposition temperature or higher in a decreasing and sintering furnace to degrease a resin component from the green part. Subsequent to the degreasing process, a sintering process of keep heating at higher temperature is performed, so that a molded object (sintered body) which is made of pure aluminum or an aluminum alloy material and in which the green part (also referred to as a green molded body) is integrated is obtained. The sintered body serves as a target object that is processed by the sintering apparatus. Meanwhile, the degreasing process and the sintering process may be sequentially performed by using the same apparatus, or may be performed by using different apparatuses.

Furthermore, the modeling system 7 performs a post-processing process using the post-processing apparatus with respect to the target object (sintered body) that is processed by using the sintering apparatus. The post-processing process is, for example, a process of coating or polishing the object. Then, the modeling system 7 performs a quality assurance test using the test apparatus with respect to the target object that is subjected to the post-processing, and generates a three-dimensional modeled object as a finished product. The conveying apparatus included in the modeling system 7 is an apparatus for conveying the processing target object among the apparatuses. Further, the modeling system 7 includes the recycle apparatus for reusing (recycling) extra powder or the like that remains through the modeling process.

Moreover, the apparatuses included in the modeling system 7 may be configured such that a single apparatus performs a plurality of processes. FIG. 3 illustrates an example in which a three-dimensional modeling apparatus that is able to perform the processes for modeling, solvent drying, extra powder removal, and degreasing and sintering as illustrated in FIG. 2 is used. In the modeling system illustrated in FIG. 3, for example, the modeling process is performed as a process including the processes for modeling, solvent drying, extra powder removal, and degreasing and sintering. Here, the modeling system 7 includes at least a process of performing a modeling process for a target object based on a predetermined modeling method and a process of performing post-processing on the target object that is subjected to the modeling process. Further, the modeling system 7 includes different apparatuses that are used for different purposes depending on the modeling method, and performs a different modeling process depending on the modeling method. While FIGS. 2 and 3 illustrate examples in which the binder jetting method (powder deposition modeling method) is used, the modeling method of the modeling system 7 is not limited to this example.

Examples of the modeling method for performing three-dimensional modeling include fused filament fabrication (FFF) that is a fused deposition modeling method, selective laser sintering (SLS, a laser sintering method) and selective laser melting (SLM) that are powder sintering additive manufacturing methods, material jetting (MJ), electron beam melting (EBM), and a stereolithography apparatus (SLA) and digital light processing that are optical modeling methods.

As described above, the modeling system 7 is able to generate a three-dimensional modeled object by performing the modeling process based on a corresponding modeling method by using a plurality of apparatuses that are used for different purposes.

Here, each of the apparatuses included in the modeling system is used for a different purpose and has different specifications, functions, and the like. For example, a processible size, a processing method, such as DRY or WET, quality, such as modeling accuracy, or a function, such as a processing speed, is different for each of the apparatuses included in the modeling system. Further, the apparatuses included in the modeling system 7 may be manufactured by different companies and may be unable to acquire certain information that is needed to cooperate with the management apparatus. In other words, in the conventional modeling system, specifications, functions, etc. of the apparatuses included in the modeling system vary among the apparatuses, and therefore, there is a problem in that it is difficult to centrally manage the apparatuses independently of apparatuses that are present in the market and that perform various special processes.

To cope with this, in the modeling management system 1, control devices 30 (30a to 30i) that can communicate with the management apparatus 10 are connected to the respective modeling systems 7. The control devices 30 control the apparatuses or communicate with the apparatuses in accordance with an instruction issued by the management apparatus 10, or monitor the apparatuses by capturing images of operation screens of the apparatuses or operation of the apparatuses, and acquire apparatus data on the operation of the apparatuses. The control devices 30 detect state changes of the apparatuses by using the acquired apparatus data, and determine states of the apparatuses by using a determination criterion that is common to all of the apparatuses that are managing targets of the management apparatus 10. Then, the modeling management system 1 transmits the determined states of the apparatuses from the control devices 30 to the management apparatus 10, and allows the management apparatus 10 to manage the states of the apparatuses.

With this configuration, by monitoring the apparatuses by using the control devices 30, the modeling management system 1 is able to manage the state of each of the apparatuses included in the modeling system 7 independently of the functions of the apparatuses included in the modeling system 7. For example, even if the apparatuses do not have means for communicating with external apparatuses, the modeling management system 1 is able to cause the apparatuses and the management apparatus 10 to cooperate with each other in real time by exchanging various kinds of data with the management apparatus 10 by using the control devices 30.

Hardware Configurations

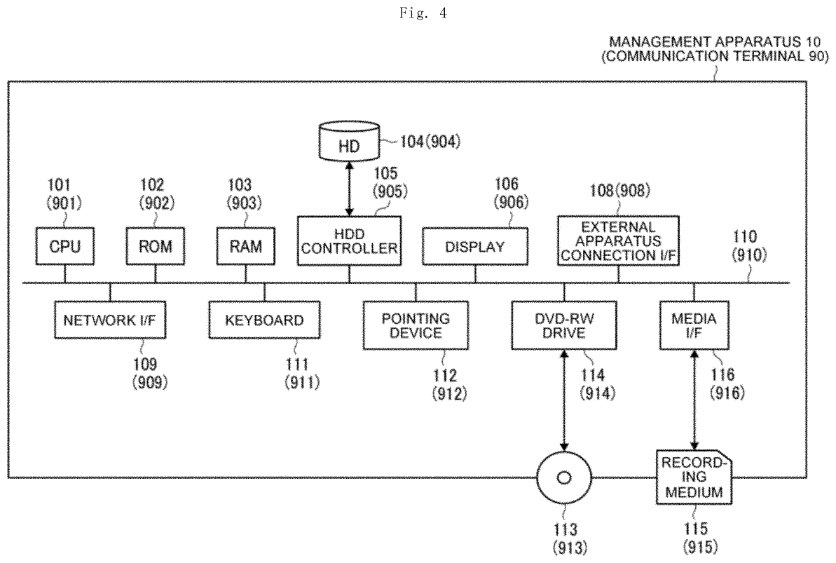

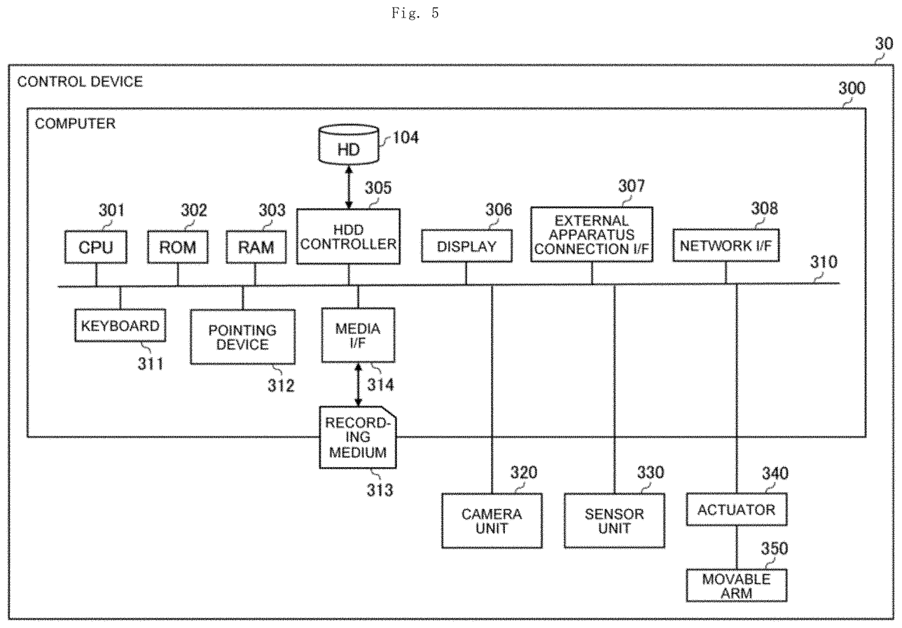

Hardware configurations of the apparatus, the device, and the terminal included in the modeling management system according to the embodiment will be described below with reference to FIGS. 4 and 5. Meanwhile, structural elements may be added to or removed from the hardware configuration illustrated in FIGS. 4 and 5 if needed.

Hardware Configuration of Management Apparatus

A hardware configuration of the management apparatus 10 will be described below with reference to FIG. 4. FIG. 4 is a diagram illustrating an example of the hardware configuration of the management apparatus. Hardware components of the management apparatus 10 are denoted by reference numbers in the 100s. The management apparatus 10 is constructed by a computer, and includes, as illustrated in FIG. 4, a central processing unit (CPU) 101, a read only memory (ROM) 102, a random access memory (RAM) 103, a hard disk (HD) 104, a hard disk drive (HDD) controller 105, a display 106, an external apparatus connection interface (I/F) 108, a network I/F 109, a bus line 110, a keyboard 111, a pointing device 112, a digital versatile disk-rewritable (DVD-RW) drive 114, and a media I/F 116.

The CPU 101 controls entire operation of the management apparatus 10. The CPU 101 is an arithmetic device that reads a program or data that is stored in the ROM 102, the HD 104, or the like onto the RAM 103, and performs a process to implement each of functions of the management apparatus 10. The ROM 102 is a non-volatile memory that stores therein a program, such as initial program loader (IPL), used to drive the CPU 101. The RAM 103 is a volatile memory that is used as a work area for the CPU 101. The HD 104 stores therein various kinds of data, such as a program. The HDD controller 105 controls read and write of various kinds of data with respect to the HD 104 under the control of the CPU 101. The display 106 displays various kinds of information, such as a cursor, a menu, a window, a character, or an image. Meanwhile, the display 106 may be a touch panel display including an input means. The external apparatus connection I/F 108 is an interface for connecting various external apparatuses. Examples of the external apparatus in this case include a universal serial bus (USB) memory and a printer. The network I/F 109 is an interface for performing data communication using the communication network 5. The bus line 110 is an address bus, a data bus, or the like for electrically connecting the components, such as the CPU 101, illustrated in FIG. 4.

Further, the keyboard 111 is a kind of input means including a plurality of keys for inputting a character, a value, various instructions, or the like. The pointing device 112 is a kind of input means for selecting or executing various instructions, selecting a processing target, or moving a cursor, for example. The input means is not limited to the keyboard 111 and the pointing device 112, but may be a touch panel, an audio input device, or the like. The DVD-RW drive 114 controls read or write of various kinds of data with respect to a DVD-RW 13 that is one example of a removable recording medium. The removable recording medium is not limited to the DVD-RW, but may be a DVD-recordable (DVD-R), Blu-ray (registered trademark) Disc, or the like. The media I/F 116 controls read or write (storage) of data with respect to a recording medium 115, such as a flash memory.

Hardware Configuration of Communication Terminal

FIG. 4 is a diagram illustrating an example of the hardware configuration of the communication terminal. Hardware components of the communication terminal 90 are denoted by reference numbers in the 900s in parentheses. The communication terminal 90 is constructed by a computer, and has the same configuration as the management apparatus 10 as illustrated in FIG. 4; therefore, explanation of each of the hardware components will be omitted.

Hardware Configuration of Control Device

FIG. 5 is a diagram illustrating an example of the hardware configuration of the control device. The control device 30 includes a computer 300 that controls a process or operation of the control device 30.

The computer 300 includes a CPU 301, a ROM 302, a RAM 303, an HD 304, an HDD controller 305, a display 306, an external apparatus connection I/F 307, a network I/F 308, a bus line 310, a keyboard 311, a pointing device 312, and a media I/F 314.

The CPU 301 controls entire operation of the control device 30. The CPU 301 is an arithmetic device that reads a program or data that is stored in the ROM 302, the HD 304, or the like onto the RAM 303, and performs a process to implement each of functions of the control device 30. The ROM 302 is a non-volatile memory that stores therein a program, such as IPL, or data used to drive the CPU 301. The RAM 303 is a volatile memory that is used as a work area for the CPU 301. The HD 304 stores therein various kinds of data, such as a program. The HDD controller 305 controls read and write of various kinds of data with respect to the HD 304 under the control of the CPU 301. The display 306 displays various kinds of information, such as a cursor, a menu, a window, a character, or an image. Meanwhile, the display 106 may be a touch panel display including an input means. The external apparatus connection I/F 307 is an interface for connecting various apparatuses included in the modeling system 7. The network I/F 308 is an interface for performing data communication using the communication network 5. The bus line 310 is an address bus, a data bus, or the like for electrically connecting the components, such as the CPU 301, illustrated in FIG. 5.

Further, the keyboard 311 is a kind of input means including a plurality of keys for inputting a character, a value, various instructions, or the like. The pointing device 312 is a kind of input means for selecting or executing various instructions, selecting a processing target, or moving a cursor, for example. The input means is not limited to the keyboard 311 and the pointing device 312, but may be a touch panel, an audio input device, or the like. The media I/F 314 controls read or write (storage) of data with respect to a recording medium 313, such as a flash memory.

Furthermore, the control device 30 includes a camera unit 320, a sensor unit 330, an actuator 340, and a movable arm 350. The camera unit 320 is an image capturing means including a predetermined camera. The sensor unit 330 includes various sensor devices for detecting operation of the apparatuses. The actuator 340 deforms the movable arm 350 on the basis of an instruction given by the CPU 301. The movable arm 350 includes an operating means that enables additional operation on an apparatus connected to the control device 30. The movable arm 350 includes, as the operating means, a hand for gripping an object, such as a part, at an end thereof, for example.

Meanwhile, each of the programs as described above may be distributed by being recorded in a computer readable recording medium in a computer-installable or computer-executable file format. Examples of the recording medium include a compact disc-recordable (CD-R), a DVD, a Blu-ray disc, a secure digital (SD) card, and a USB memory. Further, the recording medium may be provided within and between countries as a program product. For example, the management system implements a management method according to the present invention by executing the program according to the present invention.

Functional Configuration

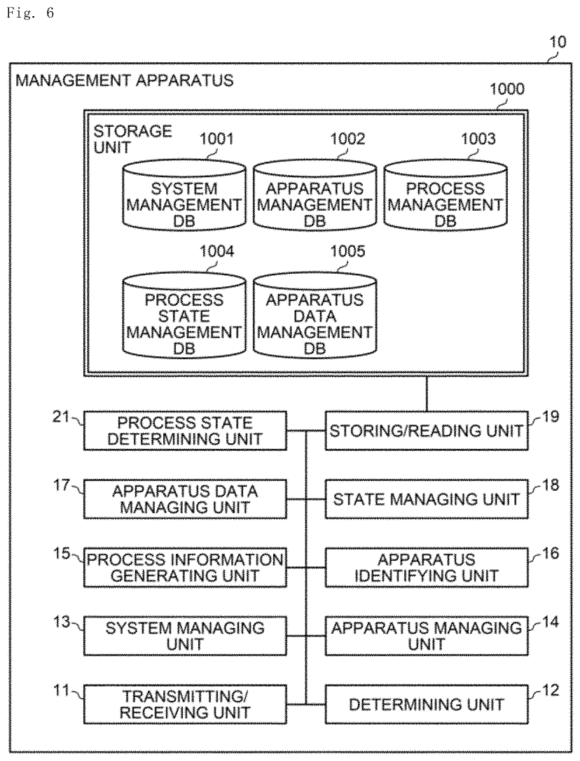

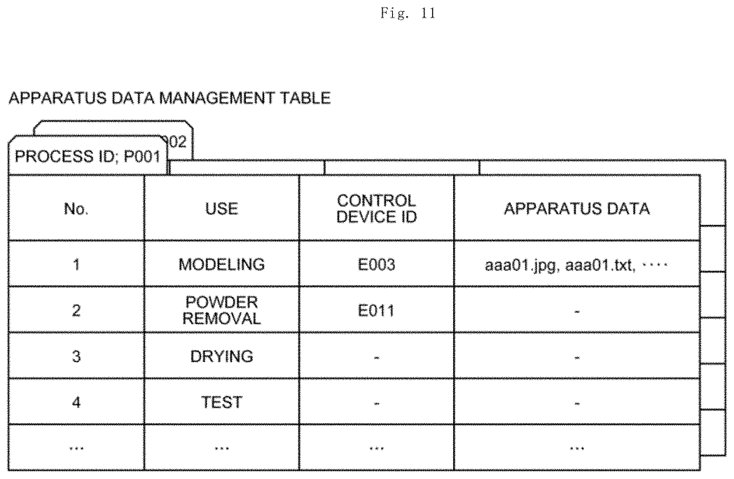

A functional configuration of the modeling management system according to the embodiment will be described below with reference to FIGS. 6 to 13. FIG. 6 is a diagram illustrating an example of a functional configuration of the management apparatus. FIG. 12 is a diagram illustrating an example of a functional configuration of the modeling management system. Meanwhile, FIGS. 6 and 12 illustrate the apparatuses and the terminals that are related to processes or operation to be described later, among the apparatuses and the terminals illustrated in FIG. 1.

Functional Configuration of Management Apparatus

The functional configuration of the management apparatus 10 will be described below with reference to FIG. 6. The management apparatus 10 includes a transmitting/receiving unit 11, a determining unit 12, a system managing unit 13, an apparatus managing unit 14, a process information generating unit 15, an apparatus identifying unit 16, an apparatus data managing unit 17, a state managing unit 18, a process state determining unit 21, and a storing/reading unit 19. Each of the units is a function or a means that is implemented by causing any of the components illustrated in FIG. 4 to operate in response to a command issued by the CPU 101 in accordance with a management apparatus program that is loaded from the HD 104 onto the RAM 103. Further, the management apparatus 10 includes a storage unit 1000 that is constructed by the ROM 102, the RAM 103, and the HD 104 illustrated in FIG. 4.

The transmitting/receiving unit 11 is mainly implemented by a process that is performed by the CPU 101 with respect to the network I/F 109, and transmits and receives various kinds of data or information to and from other apparatuses or terminals via the communication network 5.

The determining unit 12 is implemented by a process performed by the CPU 101, and performs various kinds of determination. The system managing unit 13 is mainly implemented by a process performed by the CPU 101, and manages the modeling system 7 at each of the sites.

The apparatus managing unit 14 is mainly implemented by a process performed by the CPU 101, and manages the apparatuses included in the modeling system 7.

The process information generating unit 15 is mainly implemented by a process performed by the CPU 101, and generates process information indicating a modeling process to be performed by the modeling system 7.

The apparatus identifying unit 16 is implemented by a process performed by the CPU 101, and identifies an apparatus that performs the modeling process indicated by the process information that is generated by the process information generating unit 15.

The apparatus data managing unit 17 is mainly implemented by a process performed by the CPU 101, and manages apparatus data on operation of each of the apparatuses included in the modeling system 7. The apparatus data is, for example, image data in which an apparatus or a target object subjected to a process by the apparatus is captured. The image data in which the apparatus is captured indicates an operation screen, such as an operation panel, of the apparatus, an operating means, such as an operation button, of the apparatus, or the like.

The state managing unit 18 is mainly implemented by a process performed by the CPU 101, and manages states of the apparatuses included in the modeling system 7 for each of modeling processes.

The process state determining unit 21 is mainly implemented by a process performed by the CPU 101, and determines a process state indicating a state of the modeling process in accordance with a state of the apparatus that performs at least one process in the modeling process.

The storing/reading unit 19 is mainly implemented by a process performed by the CPU 101, stores various kinds of data (or information) in the storage unit 1000, and reads various kinds of data (or information) from the storage unit 1000.

System Management Table

FIG. 7 is a schematic diagram illustrating an example of a system management table. The system management table manages system information indicating information on the modeling system 7. In the storage unit 1000, a system management database (DB) 1001 configured with the system management table illustrated in FIG. 7 is constructed. The system management table manages system information in which a system identification data (ID) and a system name for identifying the modeling system 7, method information indicating a modeling method of the modeling system 7, location information indicating an installation location of the modeling system 7, and availability information indicating whether the modeling system 7 is available are associated with one another.

Among the pieces of information as described above, the method information indicates a modeling method that corresponds to a use of each of the apparatuses included in the modeling system 7. Further, the location information indicates information for identifying a site at which the modeling system 7 is installed. Meanwhile, the location information may be information on the latitude and the longitude indicating the location of the modeling system 7. Furthermore, in the availability information, a flag of “enabled” is associated with the modeling system 7 that is available and a flag of “disabled” is associated with the modeling system 7 that is not available. A case in which the modeling system 7 is not available is, for example, a case in which the modeling system 7 is being used or being subjected to maintenance, or a case in which an error occurs in any of the apparatuses included in the modeling system 7.

Even if the apparatuses are classified into the modeling systems 7 by the use, the installation locations, or the like, the management apparatus 10 is able to manage the plurality of modeling systems 7 in units of modeling systems by using the system management table as illustrated in FIG. 7. Therefore, the management apparatus 10 is able to flexibly manage gropes in accordance with a responsible area, maintenance operation, or the like of a maintenance responsible person, for example. Moreover, by managing availability of each of the modeling systems 7, the management apparatus 10 is able to reflect the availabilities of the modeling systems 7 in real time when coping with the responsible area of the maintenance responsible person, group management for maintenance, replacement of parts, or the like, for example.

Apparatus Management Table

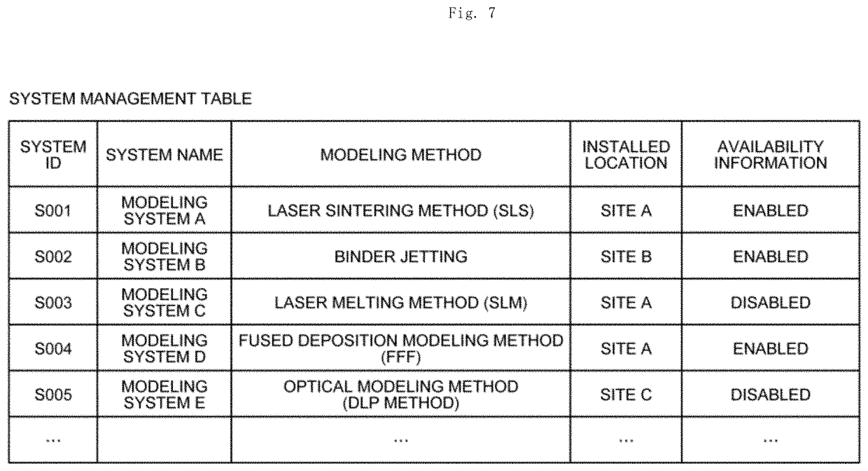

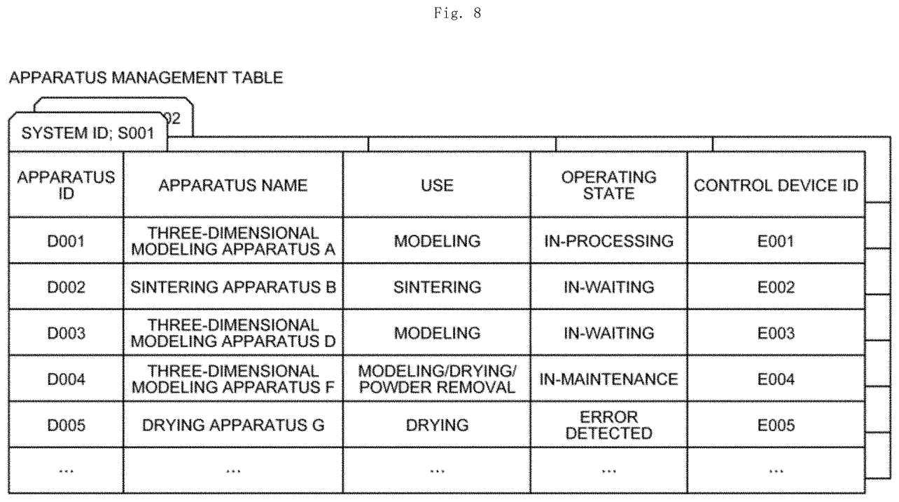

FIG. 8 is a schematic diagram illustrating an example of an apparatus management table. The apparatus management table manages apparatus information indicating information on the apparatuses included in the modeling system 7. In the storage unit 1000, an apparatus management DB 1002 configured with the apparatus management table illustrated in FIG. 8 is constructed. The apparatus management table manages, for each of system IDs that identify the modeling systems 7, apparatus information in which apparatus IDs and apparatus names for identifying the apparatuses included in the modeling system 7, the use information indicating the uses of the apparatuses, operating state information indicating operating states of the apparatuses, and control device IDs for identifying the control devices 30 connected to the respective apparatuses are associated with one another.

Among the pieces of information as described above, the use information indicates uses of processes to be performed by the apparatuses in the modeling process. Examples of the uses of the processes include, modeling, solvent drying (drying), extra powder removal (powder removal), quality assurance, degreasing, sintering, and post-processing as illustrated in FIG. 2. Further, as the use information associated with an apparatus ID of “D004”, a plurality of uses are associated with an apparatus that is able to perform processes for the plurality of uses. Furthermore, the operating state information indicates the operating states, such as in-processing, waiting, in-maintenance, error (e.g., failure or suspension) detected, of the apparatuses.

Process Management Table

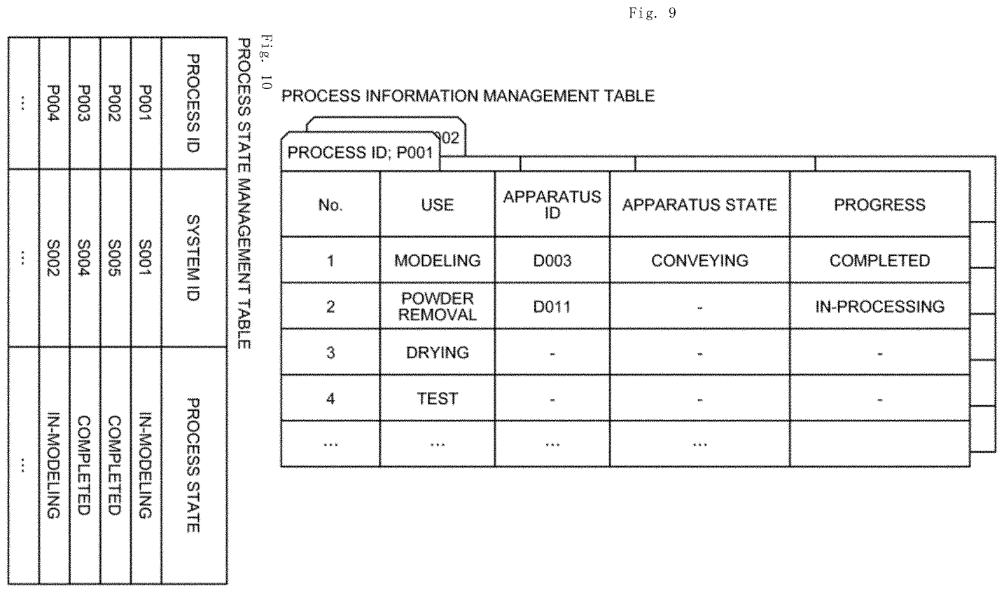

FIG. 9 is a schematic diagram illustrating an example of a process management table. The process management table manages process information indicating a modeling process for generating a three-dimensional modeled object. In the storage unit 1000, a process management DB 1003 that is configured with the process management table illustrated in FIG. 9 is constructed. The process management table manages, for each of process IDs that identify modeling processes, the process information in which a processing order (No.) of processes to be performed for the modeling process, process use information indicating a use of each of the processes, the apparatus ID for identifying an apparatus that performs the process, the apparatus state information indicating a state of the apparatus, and progress information indicating progress of the process performed by the apparatus are associated with one another.

Among the pieces of information as described above, the apparatus state information indicates apparatus states that are determined by the control devices 30. Further, in the progress information, a flag of “completed” is associated with an apparatus that has completed a process and a flag of “in processing” is associated with an apparatus that is performing a process. The process information illustrated in FIG. 9 indicates that, in a modeling process with a process ID of “P001”, apparatuses that perform processes corresponding to the processing orders of No. 1 and No. 2 are identified and the process corresponding to the processing order of No. 2 is being performed by the corresponding apparatus (an apparatus ID of “D011”).

Process State Management Table

FIG. 10 is a schematic diagram illustrating an example of a process state management table. In the storage unit 1000, a process state management DB 1004 that is configured with the process state management table illustrated in FIG. 10 is constructed. The process state management table manages a process ID for identifying the modeling process, a system ID for identifying the modeling system 7 that performs the modeling process, and process state information indicating a state of the modeling process in an associated manner. Among the pieces of information as described above, in the process state information, a flag of “in-modeling” is associated with a modeling process being performed and a flag of “completed” is associated with a completed modeling process.

Apparatus Data Management Table

FIG. 11 is a schematic diagram illustrating an example of an apparatus data management table. In the storage unit 1000, an apparatus data management DB 1005 that is configured with the apparatus data management table illustrated in FIG. 11 is constructed. The apparatus data management table manages, for each of the process IDs that identify the modeling processes, the processing order (No.) of processes to be performed for the modeling process, the process use information indicating a use of each of the processes, the control device ID for identifying the control device 30 connected to the apparatus that performs the process, and apparatus data on operation of the apparatus connected to the control device 30, in an associated manner.

Functional Configuration of Control Device

A functional configuration of the control device 30 will be described below with reference to FIG. 12. The control device 30 includes a transmitting/receiving unit 31, an accepting unit 32, a display control unit 33, a determining unit 34, a monitoring control unit 35, an apparatus data acquiring unit 36, a state change detecting unit 37, a state determining unit 38, a communication unit 41, and a storing/reading unit 39. Each of the units described above is a functions or a means that is implemented by causing any of the components illustrated in FIG. 5 to operate in response to a command that is issued by the CPU 301 in accordance with a control device program that is loaded from the HD 304 onto the RAM 303. Further, the control device 30 includes a storage unit 3000 that is configured with the ROM 302, the RAM 303, and the HD 304 illustrated in FIG. 5.

The transmitting/receiving unit 31 is mainly implemented by a process performed by the CPU 301 with respect to the network I/F 308, and transmits and receives various kinds of data or information to and from other apparatuses or terminals via the communication network 5.

The accepting unit 32 is mainly implemented by a process performed by the CPU 301 with respect to the keyboard 311 or the pointing device 312, and accepts various kinds of selection or input from a user. The display control unit 33 is mainly implemented by a process performed by the CPU 301, and displays various screens on a display unit, such as the display 306. The determining unit 34 is implemented by a process performed by the CPU 301, and performs various kinds of determination.

The monitoring control unit 35 is mainly implemented by a process performed by the CPU 301, and controls monitoring of the apparatuses included in the modeling system 7. For example, the monitoring control unit 35 performs a process of capturing an image of an apparatus or an object generated by the apparatus, by using the camera unit 320. Further, the monitoring control unit 35 acquires sensing data that is a detection result obtained by a predetermined sensor device included in the sensor unit 330, for example. Furthermore, the monitoring control unit 35 controls the apparatus by operation of the movable arm 350 by deforming the movable arm 350 or changing an orientation of the movable arm 350 via the actuator 340.

The apparatus data acquiring unit 3 is mainly implemented by a process performed by the CPU 301, and acquires the apparatus data on the operation of the apparatus. For example, the apparatus data acquiring unit 36 acquires, as the apparatus data, image data in which the apparatus is captured by the camera unit 320. Further, the apparatus data acquiring unit 36 receives, by the communication unit 41, various kinds of data transmitted from the apparatus, and receives the apparatus data, for example.

The state change detecting unit 37 is mainly implemented by a process performed by the CPU 301, and detects a state change of an apparatus in accordance with the apparatus data acquired by the apparatus data acquiring unit 36.

The state determining unit 38 is mainly implemented by a process performed by the CPU 301, and determines a state of an apparatus that is connected to the control device 30, by using the apparatus data acquired by the apparatus data acquiring unit 36 and reference data corresponding to reference states of an apparatus that is a management target. The reference states are pieces of state information that are assigned as states of the apparatus that is a management target of the management apparatus 10. Further, the reference data is data that serves as determination criteria for determining which of the reference states corresponds to the state of the apparatus. The state determining unit 38 determines the state of the apparatus that is a management target of the management apparatus 10, on the basis of the reference states that are uniform criteria.

The communication unit 41 is implemented by a process performed by the CPU 301 with respect to the external apparatus connection I/F 307, and receives input of various kinds of data or information from an apparatus connected to the control device 30.

The storing/reading unit 39 is mainly implemented by a process performed by the CPU 301, stores various kinds of data (or information) in the storage unit 3000, and reads various kinds of data (or information) from the storage unit 3000.

Condition Information Management Table

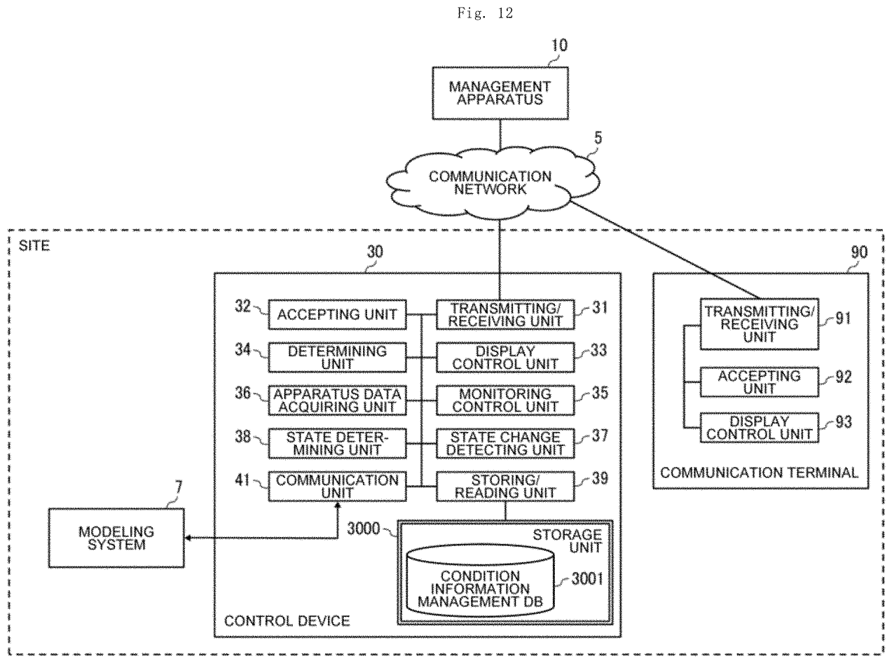

FIG. 13 is a schematic diagram illustrating an example of a condition information management table. The condition information management table manages condition information indicating a condition for determining the state of the apparatus. In the storage unit 3000, a condition information management DB 3001 that is configured with the condition information management table illustrated in FIG. 13 is constructed. The condition information management table manages condition information in which reference state information indicating the reference states of the apparatus that is a managing target and reference data indicating teacher data corresponding to the reference states are associated with one another.

Among the pieces of information as described above, the reference state information indicates the reference states of the apparatuses that are integrally managed by the management apparatus 10. The reference states are, for example, waiting, in-modeling, elimination, taking in, taking out, and afterheat. Further, the reference data is image data or binary data (character string) that serves as a determination criterion for each of the reference states. The state determining unit 38 determines at least one of the reference states indicated by the condition information management DB 3001 as the apparatus state. Meanwhile, the reference data may be data that is set in advance in the condition information management DB 3001, or may be trained and updated while the management apparatus 10 continues to manage the apparatuses. Furthermore, the reference data may be updated by learning based on the apparatus data acquired by the control device 30.

Here, “waiting” is a state in which a process is not yet performed by the apparatus. Further, “in-modeling” is a state in which the apparatus is performing a process of generating a three-dimensional modeled object. Furthermore, “elimination” is a state in which, in an extra powder removal process performed by the powder removal apparatus or the like that is one example of the apparatus, extra powder or the like that is an unnecessary material in the generated three-dimensional modeled object is removed (eliminated). Meanwhile, “elimination” includes a state in which an unnecessary portion (material) in the three-dimensional modeled object is cut, depending on the modeling method. Moreover, “taking in” is a state in which a processing target object as a processing target for the apparatus is being taken in. The processing target object is a raw material for generating the three-dimensional modeled object or a target object that is subjected to pre-processing. Furthermore, “taking out” is a state in which the target object subjected to the process by the apparatus is taken out. Moreover, “afterheat” is a state in which heating to predetermined temperature is being performed in a degreasing and sintering process performed by the sintering apparatus that is one example of the apparatus. Meanwhile, the reference states are not limited to the above-described examples, and may appropriately be modified or changed depending on the type or the like of the modeling system 7 that is the management target of the management apparatus 10.

Functional Configuration of Communication Terminal

A functional configuration of the communication terminal 90 will be described below with reference to FIG. 12. The communication terminal 90 includes a transmitting/receiving unit 91, an accepting unit 92, and a display control unit 93. Each of the units is a function or a means that is implemented by causing any of the components illustrated in FIG. 4 in response to a command issued by a CPU 901 in accordance with a control device program that is loaded from an HD 904 onto a RAM 903.

The transmitting/receiving unit 91 is mainly implemented by a process that is performed by the CPU 901 with respect to a network I/F 909, and transmits and receives various kinds of data or information to and from other apparatuses or terminals via the communication network 5.

The accepting unit 92 is mainly implemented by a process that is performed by the CPU 901 with respect to a keyboard 911 or a pointing device 912, and accepts various kinds of selection or input from a user.

The display control unit 93 is mainly implemented by a process performed by the CPU 901, and displays various images, characters, and the like on the display 906. For example, the display control unit 93 displays various display screens on the display 306 by using a Web browser or a dedicated application.

Processes or Operation According to Embodiment

Determination of Modeling Process

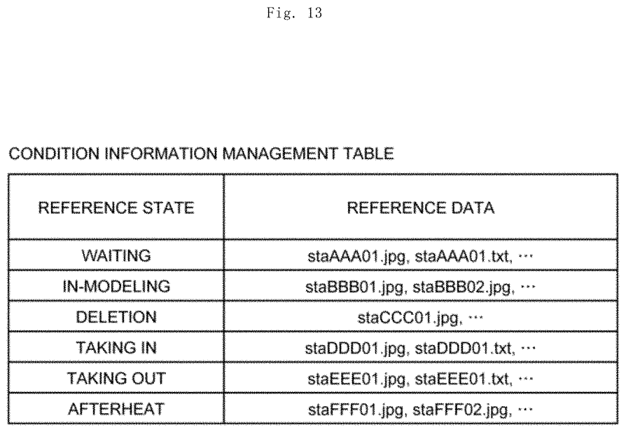

Processes or operation of the modeling management system according to the embodiment will be described below with reference to FIG. 14 to FIG. 19. First, a modeling process determination process using the modeling system 7 in the management apparatus 10 will be descried with reference to FIG. 14. FIG. 14 is a sequence diagram illustrating an example of the modeling process determination process in the management apparatus.

First, the transmitting/receiving unit 91 of the communication terminal 90 transmits, to the management apparatus 10, modeling information that is received by predetermined input operation performed by an operator (Step S11). The modeling information includes modeling data indicating a shape of a three-dimensional modeled object to be generated, method information indicating a modeling method for the three-dimensional modeled object to be generated, and location information indicating an installed location of the modeling system 7 that performs the modeling process. Among the pieces of information as described above, the modeling data is, for example, model data (for example, stereolithography (STL) data) of a three-dimensional shape using 3D-CAD, 3DCG, or the like data. Meanwhile, the modeling information may include a modeling condition that is used in the modeling process. Examples of the modeling condition include nozzle temperature, lower surface temperature (build plate), environmental temperature (air or inside of a chamber), a nozzle moving speed, a material ejection speed, a tool path (way to draw a trajectory of the nozzle), a deposition thickness (thickness of a single layer), and a physical property value of a material (Young's modulus, Poisson's ratio, rigidity (modules of rigidity), linear coefficient of expansion, density, specific heat, thermal conductivity, or the like). With this configuration, the transmitting/receiving unit 11 of the management apparatus 10 receives the modeling information transmitted from the communication terminal 90.

Subsequently, the system managing unit 13 of the management apparatus 10 identifies the modeling system 7 that performs the modeling process for generating the three-dimensional modeled object based on the modeling information received at Step S11 (Step S12). Specifically, the system managing unit 13 searches through the system management DB 1001 (see FIG. 7) by using the received method information and the received location information as search keys, reads the system information that is associated with a combination of the method information and the location information that are the same as the received method information and the received location information, and uniquely identifies the modeling system 7.

Subsequently, the process information generating unit 15 generates the process information indicating the modeling process to be performed by the modeling system 7 identified at Step S12 (Step S13). Specifically, the process information generating unit 15 sets, as the process information, processes (uses) in sequence in order to perform processes corresponding to the modeling method of the identified modeling system 7. Meanwhile, at Step S13, the process information generating unit 15 sets only the sequence of the uses (processes) and the process information at this time does not include information on the apparatuses that perform the processes. The process information generating unit 15 stores the generated process information in the process management DB 1003 (see FIG. 9) via the storing/reading unit 19.

Subsequently, the state managing unit 18 stores a process state indicating the state of the modeling process corresponding to the process information generated at Step S13, in the process state management DB 1004 (see FIG. 10) via the storing/reading unit 19 (Step S14). Specifically, the state managing unit 18 stores the process state of “in-processing” in association with the process ID and the system ID corresponding to the process information generated at Step S13.

In this manner, the management apparatus 10 is able to determine and manage the modeling process for generating a target three-dimensional modeled object, in accordance with the modeling information transmitted from the communication terminal 90.

Management of States of Apparatuses

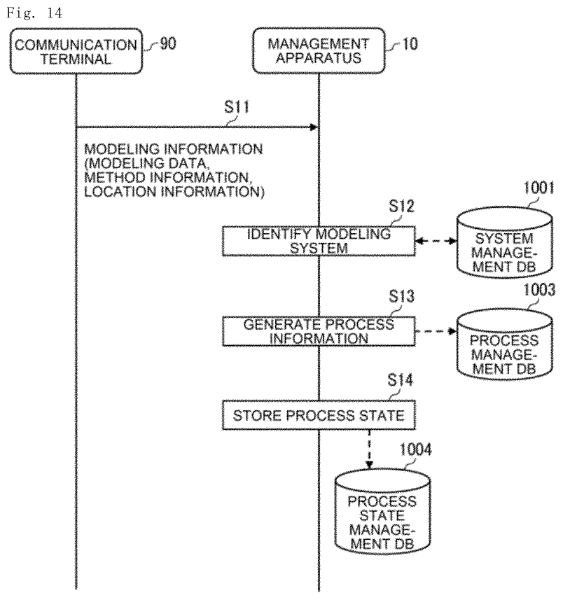

Management of the states of the apparatuses included in the modeling system 7 will be described below with reference to FIG. 15 to FIG. 19. FIG. 15 is a sequence diagram illustrating an example of an apparatus state management process in the modeling management system.

First, the apparatus identifying unit 16 of the management apparatus 10 identifies the apparatuses that perform the processes indicated by the process information generated at Step S13 (Step S21). Specifically, the apparatus identifying unit 16 identifies an apparatus that performs the first process (No. 1) among the processes indicated by the process information. In the example in FIG. 9, the apparatus identifying unit 16 identifies an apparatus with an apparatus ID of “D003” as an apparatus used for “modeling” that is the first process.

Subsequently, the apparatus managing unit 14 updates an operating state of the apparatus identified at Step S21 (Step S22). Specifically, the apparatus managing unit 14 updates the operating state information that is associated with the apparatus identified by the apparatus identifying unit 16 in the apparatus information stored in the apparatus management DB 1002 (see FIG. 8) from “in-waiting” to “in-processing”.

Subsequently, the transmitting/receiving unit 11 transmits a process start request for the modeling process to the control device 30 that is connected to the apparatus identified at Step S21 (Step S23). The process start request includes the modeling data received at Step S11. Further, the control device 30 serving as a transmission destination is a control device that corresponds to the control device ID that is associated with the apparatus ID of the apparatus identified at Step S21 in the apparatus information stored in the apparatus management DB 1002. Accordingly, the transmitting/receiving unit 31 of the control device 30 receives the process start request transmitted from the management apparatus 10.

Subsequently, the communication unit 41 of the control device 30 transmits (transfers), to the connected apparatus, the process start request that is transmitted from the management apparatus 10 (Step S24). Meanwhile, the process start request for the apparatus need not always be transmitted from the management apparatus 10 via the control device 30, but may be directly input to the apparatus via a predetermined operating means included in the apparatus.

The apparatus included in the modeling system 7 performs the requested process (Step S25). In this example, the three-dimensional modeling apparatus that is one example of the apparatus performs a target object modeling process that is one process in the modeling process for generating a three-dimensional modeled object, by using the modeling data included in the received process start request, for example. Then, the control device 30 performs a state monitoring process on the apparatus that performs the process at Step S25 (Step S26).

Apparatus State Monitoring

One example of an apparatus state monitoring process performed by the control device 30 will be described in detail below with reference to FIGS. 16 to 18. FIG. 16 is a flowchart illustrating an example of the apparatus state monitoring process.

First, the accepting unit 32 of the control device 30 accepts input of a predetermined control request in accordance with input that is performed by the operator with respect to the keyboard 311 or the like (Step S41). The control request may be an image capturing instruction for the camera unit 320 or operation control for the movable arm 350, for example. Then, the monitoring control unit 35 performs predetermined control in accordance with the control request accepted at Step S41 (Step S42). Meanwhile, a trigger to cause the monitoring control unit 35 to perform control is not limited to acceptance of input at Step S41, but the monitoring control unit 35 may automatically perform predetermined control at a predetermined timing that is determined in advance.

Subsequently, the apparatus data acquiring unit 36 acquires, as a control result obtained by the monitoring control unit 35, the apparatus data on the operation of the apparatus (Step S43). Then, the state change detecting unit 37 detects a change in the apparatus state on the basis of the apparatus data acquired at Step S43 (Step S44). Specifically, the state change detecting unit 37 detects a change in the apparatus state by comparing pieces of apparatus data that are continually acquired. For example, the state change detecting unit 37 detects, as a state change, a change in the operation screen by comparing pieces of image data in which the operation screen of the apparatus is captured. Further, for example, the state change detecting unit 37 detects, as the state change, a change in the operating means by using image data in which the operating means, such as an operation button, of the apparatus is captured. Furthermore, for example, the state change detecting unit 37 receives data (for example, binary data) that is transmitted from the apparatus by using the communication unit 41, and detects a change in the apparatus state on the basis of the received data.

If the state change detecting unit 37 detects a change in the apparatus state (YES at Step S44), the process goes to Step S45. In contrast, if the state change detecting unit 37 does not detect a change in the apparatus state (NO at Step S44), the processes are repeated from Step S42.

Subsequently, if the state determining unit 38 detects a change in the apparatus state at Step S44, the state determining unit 38 determines the apparatus state for which the state change is detected (Step S45). Specifically, the state determining unit 38 refers to the condition information that is stored in the condition information management DB 3001 (see FIG. 13), and determines the apparatus state by using the reference data that is included in the apparatus data acquired at Step S43 and the condition information.

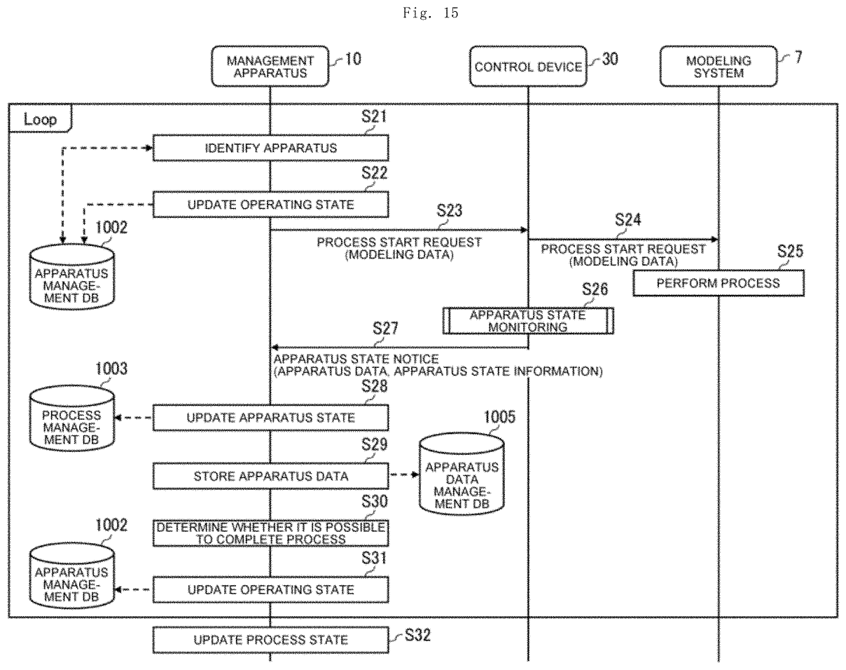

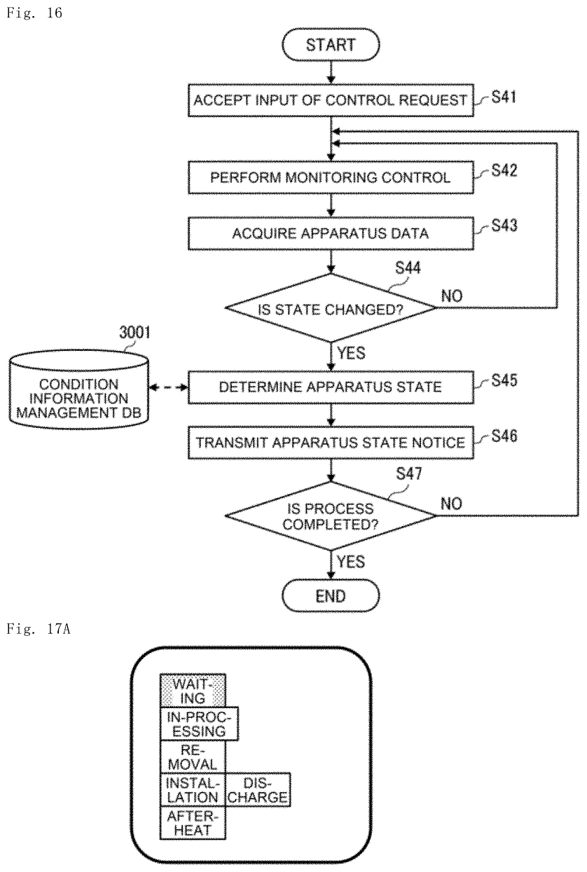

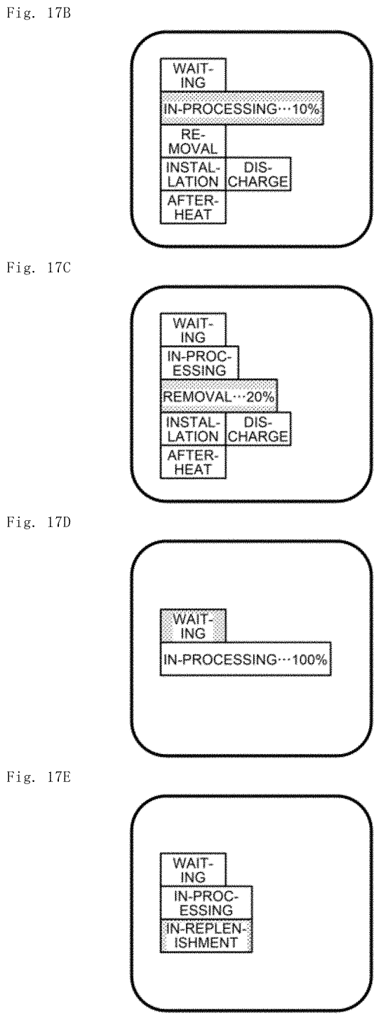

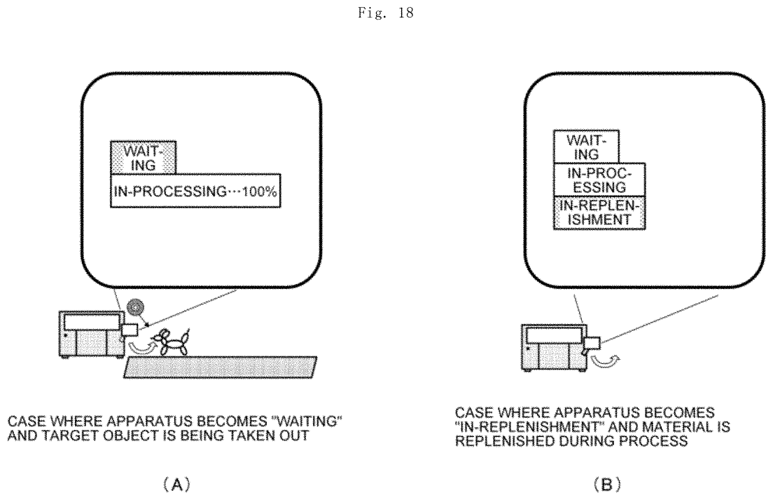

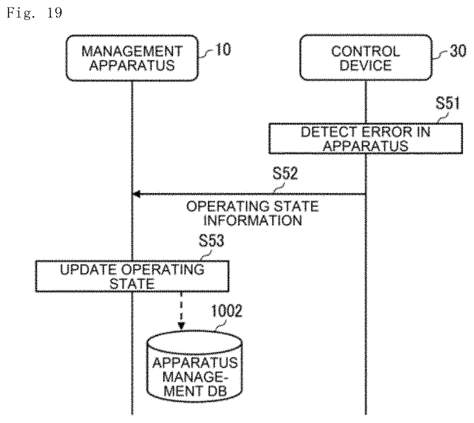

An apparatus state determination process will be described in detail below with reference to FIGS. 17A to 18. FIGS. 17A to 17E are diagrams for explaining examples of the apparatus data. FIG. 17A to 17E illustrate examples of image data of an operation screen, such as an operation panel, that is included in each of the apparatuses, where the image data is one example of the apparatus data. The control device 30 captures an image of the operation screen of the apparatus by using the camera unit 320 and acquires, as the apparatus data, image data of the operation screen.

FIG. 17A illustrates a display example in which it is determined that the apparatus is in waiting, FIG. 17B illustrates a display example in which it is determined that the apparatus is performing modeling, and FIG. 17C illustrates a display example in which it is determined that the apparatus is performing elimination. Further, FIG. 17D illustrates a display example in which it is determined that the apparatus is in waiting state, and FIG. 17E illustrates a display example in which it is determined that the apparatus is performing replenishment.

The apparatus data illustrated in FIGS. 17A to 17C is data that is obtained when the apparatus determines the state in accordance with the same determination criteria as the reference states stored in the condition information management DB 3001, for example. In this case, the state determining unit 38 determines, as the apparatus state, the state indicated by the operation screen that is captured in the acquired image data. Specifically, the control device 30 stores therein, as the reference data, the same image data as the image data illustrated in FIGS. 17A to 17C, and the state determining unit 38 determines, as the apparatus state, the reference state that is associated with the same image data (reference data) as the acquired image data.

In contrast, the apparatus data illustrated in FIGS. 17D and 17E is data that is obtained when the apparatus determines the state in accordance with the same determination criteria as the reference states stored in the condition information management DB 3001, for example. Among the apparatuses included in the modeling system 7, determination criteria for the respective states, display modes of the operation screens, or the like are different. For example, in the operation screen illustrated in FIG. 17D, the number of displayed items of states is reduced as compared to the reference states, and, in the operation screen illustrated in FIG. 17E, an item of “in-replenishment” is added that is not included in the reference states. In this case, the state determining unit 38 determines, as the apparatus state, a state that is captured in the image data acquired at Step S43 and that is different from the state determined by the apparatus.

FIG. 18 is a diagram for schematically explaining an example of the apparatus state determination process. FIG. 18 illustrates, at (A), an operating state of the apparatus that is displaying the operation screen illustrated in FIG. 17D. The apparatus illustrated at (A) in FIG. 18 is in the waiting state and in the state in which a processed object is being taken out, for example. In this case, the state determining unit 38 determines the apparatus state by using the image data in which the operation screen is captured and the image data in which surroundings of the entire apparatus including the processed object are captured. In this example, the state determining unit 38 determines “taking out” as the apparatus state.

In this manner, the control device 30 determines the apparatus state by using a plurality of pieces of apparatus data acquired by the apparatus data acquiring unit 36. When performing the process illustrated at (A) in FIG. 18, the control device 30 stores, as the reference data, a combination of the plurality of pieces of image data that are used as determination criteria for determining the apparatus state in the condition information management DB 3001.

Further, FIG. 18 illustrates, at (B), an operating state of the apparatus that is displaying the operation screen illustrated in FIG. 17D. The apparatus illustrated at (B) in FIG. 18 is in a state in which a material or the like for generating a three-dimensional modeled object is being replenished while the apparatus is performing modeling, for example. In this case, the state determining unit 38 determines the apparatus state by using the image data in which the operation screen is captured and a condition for a change to a reference state with respect to the states that are captured in the image data. In this example, the state determining unit 38 determines “in-modeling” as the apparatus state.

In this manner, the control device 30 determines the apparatus state by using the apparatus data acquired by the apparatus data acquiring unit 36 and the condition for a change to the reference state. When performing the process illustrated at (B) in FIG. 18, the control device 30 stores, as the reference data, a combination of the image data and the condition for a change that are used as the determination criteria for determining the apparatus state in the condition information management DB 3001.

Meanwhile, a method of determining the apparatus state by the state determining unit 38 is not limited to the examples as illustrated in FIGS. 17A to 18, but it may be possible to determine the apparatus state by using, for example, image data in which the operating means, such as an operation button, of the apparatus is captured, binary data transmitted from the apparatus, or the like. By storing, as the reference data, the image data, the binary data, or the condition for a change as described above in the condition information management DB 3001 in association with the reference states, the control device 30 is able to determine the apparatus state by using various kinds of apparatus data on the operation of the apparatus. Meanwhile, it is preferable to use the image data as the reference data because an amount of information in the image data is large. The binary data only allows data with certain contents that are determined in advance, and data volume of the binary data is limited, so that it is difficult to always perform determination with the same amount of information as the image data. In contrast, the amount of information in the image data is not limited, and it is possible to handle information on a captured object as the image data, so that it is possible to simplify the apparatus state determination process and improve accuracy of the apparatus state determination process.

Then, the transmitting/receiving unit 31 transmits, to the management apparatus 10, an apparatus state notice indicating the determined apparatus state (Step S46). If the process performed by the apparatus is completed (YES at Step S47), the control device 30 terminates the process. In contrast, if the process performed by the apparatus is not completed (NO at Step S47), the control device 30 repeats the processes from Step S42.

In this manner, the control device 30 is able to determine the apparatus state while eliminating differences among the connected apparatuses, by using the apparatus data acquired from the apparatuses and the stored reference data.

Referring back to FIG. 15 the transmitting/receiving unit 31 of the control device 30 transmits the apparatus state notice indicating the apparatus state to the management apparatus 10 (Step S27). The apparatus state notice includes the apparatus data acquired at Step S43 and the apparatus state information indicating the apparatus state. Accordingly, the transmitting/receiving unit 11 of the management apparatus 10 receives the apparatus state notice transmitted from the control device 30. Meanwhile, time information indicating a time at which the apparatus data acquiring unit 36 acquires the apparatus data or a time at which the state determining unit 38 performs the state determination process by using the apparatus data is added to the apparatus data included in the apparatus state notice.

Subsequently, the state managing unit 18 of the management apparatus 10 updates the apparatus state stored in the process management DB 1003 (see FIG. 9), on the basis of the apparatus state information received at Step S27 (Step S28). Specifically, the state managing unit 18 updates the apparatus state indicated by the process information that is associated with the apparatus ID of the apparatus corresponding to the received apparatus state information, among the pieces of process information stored in the process management DB 1003. In this case, the state managing unit 18 updates the apparatus state associated with the apparatus ID of “D003” from “in-processing” to “completed”.

Further, the apparatus data managing unit 17 stores the apparatus data received at Step S27 in the apparatus data management DB 1005 (see FIG. 11) in association with the control device ID of the control device 30 that has transmitted the apparatus data (Step S29). The apparatus data managing unit 17 chronologically stores and manages the apparatus data transmitted from the control device 30, on the basis of the time information added to the apparatus data.

Subsequently, the determining unit 12 determines whether it is possible to complete the process related to the process start request transmitted at Step S23 (Step S30). If it is determined that the process is completed at Step S30, the apparatus managing unit 14 updates the operating state of the apparatus stored in the apparatus management DB 1002 (Step S31). Specifically, the apparatus managing unit 14 updates the operating state information that is associated with the apparatus that has transmitted the process start request among the pieces of apparatus information stored in the apparatus management DB 1002 from “in-processing” to “in-waiting”.

If the management apparatus 10 determines, at Step S30, that the process being performed (an apparatus (for example, a first apparatus) corresponding to the processing order of “No. 1”) is completed, the management apparatus 10 repeats the processes from Step S21 to perform a next process (an apparatus (for example, a second apparatus) corresponding to the processing order of “No. 2”) that is indicated in the process information. In this manner, the management apparatus 10 identifies the apparatus (for example, the second apparatus) that requests a next process, at a timing at which the process performed by the apparatus (for example, the first apparatus) is completed, so that it is possible to effectively use the apparatus in accordance with the operating states in real-time.

Then, if all of the processes indicated by the process information generated at Step S13 are completed, the management apparatus 10 updates a state of the modeling process stored in the process state management DB 1004 (Step S32). Specifically, the process state determining unit 21 determines the state of the modeling process in accordance with the apparatus state information received at Step S27. In this case, for example, if all of progress states among the pieces of process information stored in the process management DB 1003 indicate “completed”, the process state determining unit 21 determines “completed” as the state of the modeling process. Then, the state managing unit 18 updates the process state that is associated with the process ID of the modeling process for which the processes are completed and that is stored in the process state management DB 1004 (see FIG. 10) from “in-modeling” to “completed”.

In this manner, by acquiring, from the control device 30, the apparatus state that is determined by the control device 30 on the basis of the reference state, the management apparatus 10 is able to appropriately manage the states of the apparatus and the modeling system 7 that perform the modeling process. Further, by appropriately managing the apparatus state, the management apparatus 10 is able to effectively use a spare time of each of the apparatuses when identifying an apparatus to be caused to perform the modeling process.

Furthermore, the modeling management system 1 is able to manage occurrence of an error due to a failure, suspension, or the like of the apparatus that is performing a predetermined process. FIG. 19 is a sequence diagram illustrating an apparatus state management process in the modeling management system. The process illustrated in FIG. 19 is one example of a process that is performed when, at Step S42 in FIG. 16, the state change detecting unit 37 detects occurrence of an error in the apparatus as the state change.

The state change detecting unit 37 of the control device 30 detects occurrence of an error in the apparatus by using the image data which is acquired by the apparatus data acquiring unit 36 and in which the operation screen or the operating means is captured, or by using binary data transmitted from the apparatus (Step S51). In this case, the control device 30 may cause the apparatus to stop the process. Then, the transmitting/receiving unit 31 of the control device 30 transmits, to the management apparatus 10, the operating state information indicating an error state of the apparatus (Step S52). Accordingly, the transmitting/receiving unit 11 of the management apparatus 10 receives the operating state information that is transmitted from the control device 30.

Then, the apparatus managing unit 14 of the management apparatus 10 updates the operating state of the apparatus stored in the apparatus management DB 1002 (see FIG. 8), on the basis of the operating state information received at Step S52 (Step S53). Specifically, the apparatus managing unit 14 updates the operating state information that is associated with the apparatus that has transmitted the process start request among the pieces of apparatus information stored in the apparatus management DB 1002 from “in-processing” to “error detected”.

In this manner, even if an error occurs in the apparatus that is performing the modeling process, the modeling management system 1 is able to allow the management apparatus 10 to recognize the occurrence of the error in the apparatus by giving a notice from the control device 30 to the management apparatus 10.

Modification of Modeling Management System

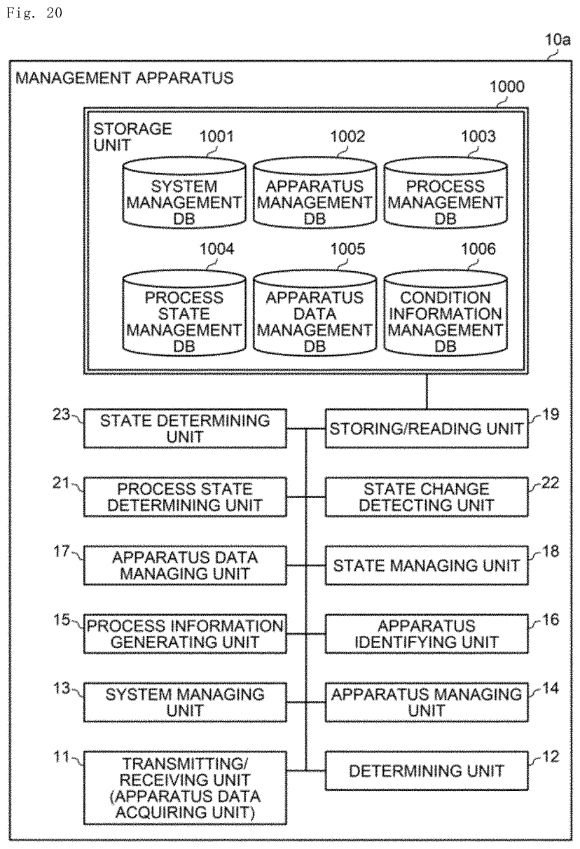

A modification of the modeling management system 1 will be described below with reference to FIGS. 20 to 22. Meanwhile, the same components and the same functions as those of the embodiment as described above are denoted by the same reference symbols, and explanation thereof will be omitted. A modeling management system according the modification causes a management apparatus 10a to perform a part of the apparatus state monitoring process as described above. The management apparatus 10a determines the state of the apparatus that performs the modeling process, by using the apparatus data that is transmitted from the control device 30 and that is managed in the apparatus data management DB 1005 (see FIG. 11).

FIG. 20 is a diagram illustrating a functional configuration of the management apparatus according to the modification. The management apparatus 10a illustrated in FIG. 20 includes, in addition to the components of the management apparatus 10 illustrated in FIG. 6, a state change detecting unit 22 and a state determining unit 23. The state change detecting unit 22 and the state determining unit 23 have the same configurations as the state change detecting unit 37 and the state determining unit 38, respectively. Further, the transmitting/receiving unit 11 has a function as an apparatus data acquiring unit that acquires apparatus data transmitted from the control device 30.

Furthermore, the management apparatus 10a includes a condition information management DB 1006 that is constructed in the storage unit 1000. The condition information management DB is configured with the condition information management table illustrated in FIG. 13.

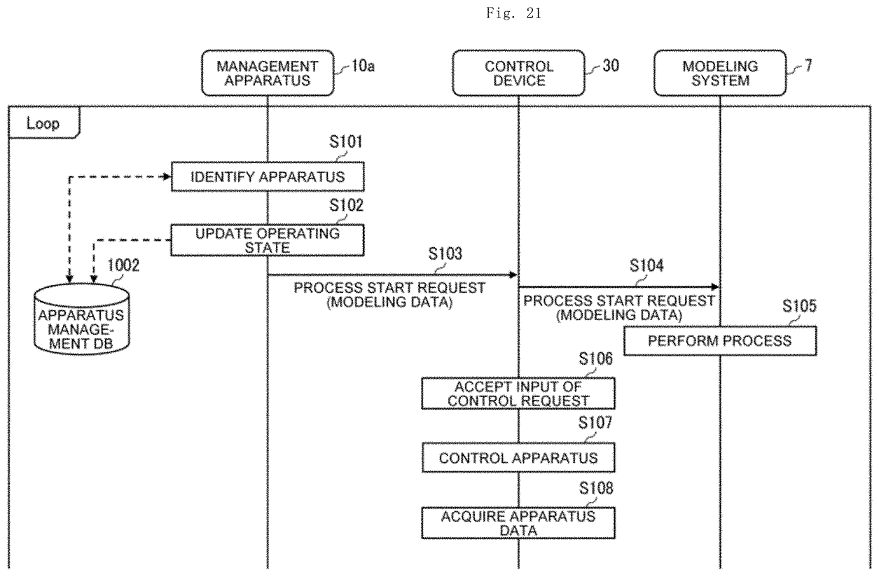

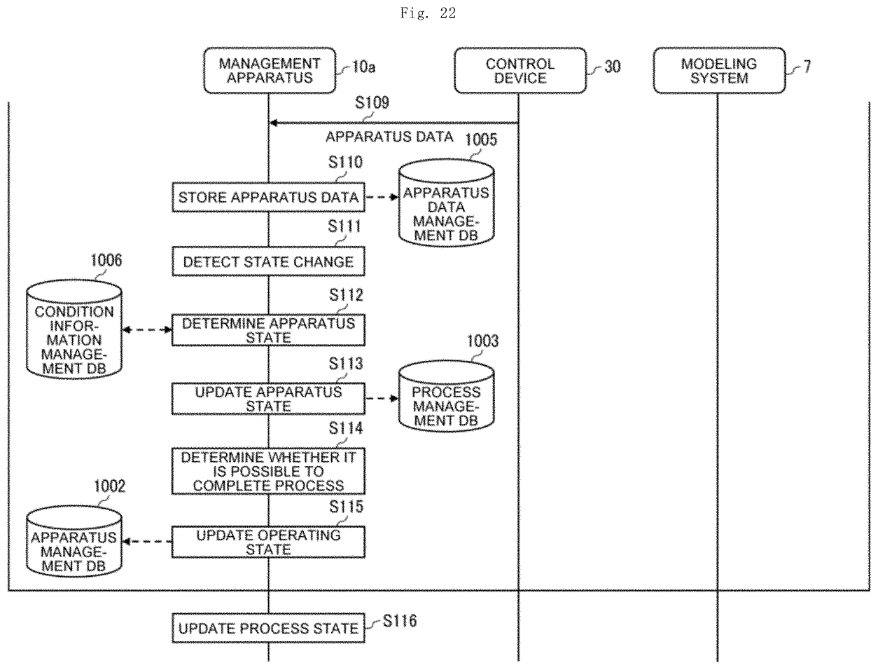

An apparatus state management process in the modeling management system 1 according to the modification will be described below with reference to FIGS. 21 and 22. FIGS. 21 and 22 are sequence diagrams illustrating the apparatus state management process in the modeling management system according to the modification. Meanwhile, processes from Step S101 to Step S105 are the same as the processes from Step S21 to Step S25 in FIG. 15, and therefore, explanation thereof will be omitted. Further, processes from Step S106 to Step S108 are the same as the processes from Step S41 to Step S43 in FIG. 16, and therefore, explanation thereof will be omitted.

At Step S109, the transmitting/receiving unit 31 of the control device 30 transmits, to the management apparatus 10a, the apparatus data acquired at Step S108 (Step S109). Accordingly, the transmitting/receiving unit 11 of the management apparatus 10a receives the apparatus data transmitted from the control device 30 and acquires the apparatus data.

Subsequently, the apparatus data managing unit 17 of the management apparatus 10a stores the apparatus data received at Step S109 in the apparatus data management DB 1005 (see FIG. 11) in association with the control device ID of the control device 30 that has transmitted the apparatus data (Step S110). In this case, similarly to Step S29, the apparatus data managing unit 17 chronologically stores and manages the apparatus data transmitted from the control device 30, on the basis of the time information added to the apparatus data.

Subsequently, the state change detecting unit 22 detects a change in the apparatus state on the basis of the apparatus data acquired at Step S109 (Step S111). Specifically, the state change detecting unit 22 detects a change in the apparatus state by comparing pieces of apparatus data that are continually acquired. A method of detecting a state change by the state change detecting unit 22 is the same as the process at Step S44. If a change in the apparatus state is detected at Step S111, the state determining unit 38 determines the apparatus state for which the state change is detected (Step S112). A method of determining the apparatus state by the state determining unit 38 is the same as the process at Step S45.

Subsequently, the state managing unit 18 updates the apparatus state stored in the process management DB 1003 (see FIG. 9), on the basis of the apparatus state determined at Step S112 (Step S113). Specifically, the state managing unit 18 updates the apparatus state indicated by the process information that is associated with the apparatus ID of the apparatus corresponding to the determined apparatus state, among the pieces of process information stored in the process management DB 1003. In this case, the state managing unit 18 updates the apparatus state associated with the apparatus ID of “D003” from “in-processing” to “completed”, for example.

Subsequently, the determining unit 12 determines whether it is possible to complete the process related to the process start request transmitted at Step S103 (Step S114). If it is determined that the process is completed at Step S114, the apparatus managing unit 14 updates the operating state of the apparatus stored in the apparatus management DB 1002 (see FIG. 8) (Step S115). Specifically, the apparatus managing unit 14 updates the operating state information that is associated with the apparatus that has transmitted the process start request among the pieces of apparatus information stored in the apparatus management DB 1002 from “in-processing” to “in-waiting”.

If the management apparatus 10a determines, at Step S114, that the process being performed (a process corresponding to the processing order of “No. 1”) is completed, the management apparatus 10a repeats the processes from Step S101 to perform a next process (a process corresponding to the processing order of “No. 2”) that is indicated in the process information.

Then, if all of the processes indicated by the process information generated at Step S13 is completed, the management apparatus 10a updates a state of the modeling process stored in the process state management DB 1004 (see FIG. 10) (Step S116). Specifically, the process state determining unit 21 determines the state of the modeling process in accordance with the apparatus state determined at Step S112. In this case, for example, if all of progress states among the pieces of process information stored in the process management DB 1003 indicate “completed”, the process state determining unit 21 determines “completed” as the state of the modeling process. Then, the state managing unit 18 updates the process state that is associated with the process ID of the modeling process for which the processes are completed and that is stored in the process state management DB 1004 from “in-modeling” to “completed”.

In this manner, by causing the management apparatus 10a to determine the apparatus state by using the apparatus data acquired from the control device 30 and the reference data, the modeling management system according to the modification is able to appropriately mange the state of the apparatus that performs the modeling process, similarly to the embodiment as described above.

### Effects of Embodiment

As described above, by determining the apparatus state by using the apparatus data on operation of the apparatus and the reference data that is a determination criterion that is common to apparatuses to be managed, and by causing the management apparatus 10 to manage the apparatus state, the modeling management system 1 is able to manage the apparatus state independently of the apparatus.

Furthermore, by transmitting the apparatus data to the management apparatus 10 via the control device 30 connected to the apparatus, the modeling management system 1 is able to cause the apparatus and the management apparatus 10 to cooperate with each other in real time even if the apparatus does not have a means for communicating with external apparatuses.

### CONCLUSION

As described above, the management system according to one embodiment of the present invention is a management system that manages apparatuses (for example, the apparatuses included in the modeling systems 7) that perform modeling processes for generating three-dimensional modeled objects acquires apparatus data on operation of the apparatuses, and determines states of the apparatuses by using the acquired apparatus data and reference data corresponding to reference states of apparatuses to be managed. With this configuration, the management system is able to manage the states of the apparatuses that perform the modeling processes independently of the apparatuses included in the modeling system 7.

Furthermore, the management system according to one embodiment of the present invention includes the control device 30 that controls operation of the apparatuses, and the management apparatus 10 that is able to communicate with the control device 30 via the communication network 5. The control device 30 includes the apparatus data acquiring unit 36 (one example of an apparatus data acquiring means) that acquires apparatus data on operation of the apparatuses, the state determining unit 38 (one example of a state determining means) that determines states of the apparatuses by using the acquired apparatus data and reference data corresponding to reference states of apparatuses to be managed, and the transmitting/receiving unit 31 (one example of a transmitting means) that transmits apparatus state information indicating the states of the apparatuses determined by the state determining unit 38 to the management apparatus 10. Further, the management apparatus 10 includes the state managing unit 18 (one example of a state managing means) that manages the states of the apparatuses indicated by the apparatus state information transmitted from the control device 30, for each of the modeling processes. With this configuration, even if the apparatuses do not have means for communicating with external apparatuses, the management system is able to cause the apparatuses and the management apparatus 10 to cooperate with one another in real time by performing various kinds of data communication with the management apparatus 10 by using the control device 30.

Moreover, the management system according to one embodiment of the present invention includes the control device 30 that controls operation of the apparatuses, and the management apparatus 10a that is able to communicate with the control device 30 via the communication network 5. The control device 30 includes the transmitting/receiving unit 31 (one example of a transmitting means) that transmits apparatus data on operation of the apparatuses to the management apparatus 10a. Further, the management apparatus 10a includes the transmitting/receiving unit 11 (one example of an apparatus data acquiring means) that acquires the apparatus data transmitted from the control device 30, the state determining unit 23 (one example of a state determining means) that determines states of the apparatuses by using the acquired apparatus data and reference data corresponding to reference states of apparatus to be managed, and the state managing unit 18 (one example of a state managing means) that manages the states of the apparatuses determined by the state determining unit 23 for each of the modeling processes. With this configuration, the management system is able to appropriately manage the states of the apparatuses that perform the modeling processes by causing the management apparatus 10a to determine the states of the apparatuses by using the apparatus data acquired from the control device 30 and the reference data.

Moreover, in the management system according to one embodiment of the present invention, each of the management apparatuses 10 and 10a includes the process information generating unit 15 (one example of a process information generating means) that generates process information indicating the modeling processes in response to a request from the communication terminal 90, and the apparatus identifying unit 16 (one example of an apparatus identifying means) that identifies apparatuses that perform the modeling processes in accordance with the modeling processes indicated by the generated process information. Furthermore, the modeling processes are processes that are performed by a first apparatus and a second apparatus, and the apparatus identifying unit 16 identifies the second apparatus when a process performed by the first apparatus is completed. With this configuration, by identifying the second apparatus that requests a next process at a timing at which the process performed by the first apparatus is completed, the management system is able to effectively use a spare time of the apparatus in accordance with the operating state in real time.

Supplemental Explanation

Each of the functions of the embodiment as described above may be implemented by a single or a plurality of processing circuitries. Here, the “processing circuitry” of the embodiment includes a processor that is programmed to implement each of the functions by software like a processor that is implemented by an electronic circuit, and further includes a device, such as an application specific integrated circuit (ASIC), a digital signal processor (DSP), a field programmable gate array (FPGA), a system on chip (SOC), a graphics processing unit (GPU), and a conventional circuit module, that is designed to implement each of the functions as described above.

Furthermore, various tables of the embodiment as described above may be generated as a learning effect through machine learning, and it is not necessary to use the tables with classification of pieces of data of each of associated items through machine learning. Here, the machine learning is a technique for allowing a computer to obtain a learning ability like a person, and indicates a technique in which the computer automatically generates an algorithm that is needed for determination, such as data identification, from learning data that is imported in advance, and performs prediction of new data by applying the algorithm. A learning method for the machine learning may be any of supervised learning, unsupervised learning, semi-supervised learning, reinforcement learning, and deep learning, or may be a learning method as a combination of the learning methods as described above, and the learning method for the machine learning is not specifically limited.

The management system, the modeling management system, the management method, and the program according to an embodiment of the present invention have been described above, but the present invention is not limited to the embodiment as described above, and addition of other embodiments, modifications, or deletions may be made within the scope that can easily be thought of by a person skilled in the art, and all of the modes that have the functions and the effects of the present invention are included in the scope of the present invention.

According to an embodiment, it is possible to manage states of apparatuses that perform a modeling process, independently of the apparatuses included in a modeling system.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

### REFERENCE SIGNS LIST

1 Modeling management system
5 Communication network
7 Modeling system
10 Management apparatus
11 Transmitting/receiving unit (one example of apparatus data acquiring means)
15 Process information generating unit (one example of process information generating means)
16 Apparatus identifying unit (one example of apparatus identifying means)
17 Apparatus data managing unit (one example of apparatus data managing means)
18 State managing unit (one example of state managing means)
21 Process state determining unit (one example of process state determining means)
22 State change detecting unit (one example of state change detecting means)
23 State determining unit (one example of state determining means)
30 Control device
31 Transmitting/receiving unit (one example of transmitting means)
36 Apparatus data acquiring unit (one example of apparatus data acquiring means)
37 State change detecting unit (one example of state change detecting means)
38 State determining unit (one example of state determining means)
90 Communication terminal

What is claimed is:

1. A management system configured to manage an apparatus configured to perform a modeling process for generating three-dimensional modeled object, the management system comprising:
an apparatus data acquiring unit configured to acquire apparatus data on an operation of the apparatus; and
a state determining unit configured to determine a state of the apparatus, using the acquired apparatus data and reference data corresponding to a reference state of the apparatus to be managed.

2. The management system according to claim 1, further comprising a state change detecting unit configured to detect a state change of the apparatus, based on the acquired apparatus data, wherein
the state determining unit is configured to determine the state of the apparatus in accordance with detection of the state change by the state change detecting unit.

3. The management system according to claim 2, wherein
the reference state comprises waiting, in-modeling, elimination, taking in, taking out, and afterheat, and
the state determining unit is configured to determine, as the state of the apparatus, at least one of the reference state.

4. The management system according to claim 1, comprising:
a control device configured to control the operation of the apparatus; and
a management apparatus capable of communicating with the control device via a communication network, wherein
the control device includes:
the apparatus data acquiring unit;
the state determining unit;
a transmitting unit configured to transmit apparatus state information indicating the state of the apparatus determined by the state determining unit to the management apparatus, and
the management apparatus includes a state managing unit configured to manage the state of the apparatus indicated by the apparatus state information transmitted from the control device, for each modeling process.

5. The management system according to claim 1, comprising:
a control device configured to control the operation of the apparatus; and
a management apparatus capable of communicating with the control device via a communication network, wherein
the control device includes a transmitting unit configured to transmit the apparatus data to the management apparatus, and
the management apparatus includes:
the apparatus data acquiring unit configured to acquire the apparatus data transmitted from the control device;
the state determining unit; and
a state managing unit configured to manage the state of the apparatus determined by the state determining unit, for each modeling process.

6. The management system according to claim 4, wherein
the management apparatus further includes:
a process information generating unit configured to generate process information indicating the modeling process in response to a request from a communication terminal; and
an apparatus identifying unit configured to identify the apparatus configured to perform the modeling process, in accordance with the modeling process indicated by the generated process information.

7. The management system according to claim 6, wherein
the modeling process comprising processes performed by a first apparatus and a second apparatus, and
the apparatus identifying unit is configured to identify the second apparatus in a case where the first apparatus completes the process.

8. The management system according to claim 5, wherein
the management apparatus further includes a process state determining unit configured to determine a state of the modeling process in accordance with the state of the apparatus determined by the state determining unit, and
the state managing unit is configured to manage the state of the apparatus and the state of the modeling process.

9. The management system according to claim 8, wherein the state of the modeling process comprises in-modeling and in-waiting.

10. The management system according to claim 8, wherein the apparatus includes apparatuses included in a plurality of modeling systems, the state managing unit is configured to manage states of the apparatuses and states of the modeling processes performed by the plurality of modeling systems.

11. The management system according to claim 4, further comprising an apparatus managing unit configured to chronologically manage the apparatus data acquired by the apparatus data acquiring unit.

12. The management system according to claim 1, wherein the apparatus data comprises image data in which one of the apparatus and a target object processed by the apparatus is captured.

13. The management system according to claim 1, wherein the modeling process includes at least a modeling process of modeling a target object and a post-processing process of performing post-processing on the target object modeled by the modeling process.

14. A modeling management system comprising:
the management system according to claim 1; and
a modeling system including the apparatus configured to perform the modeling process.

15. A management method implemented by a management system configured to manage an apparatus configured to perform a modeling process for generating a three-dimensional modeled object, the management method comprising:
acquiring apparatus data on an operation of the apparatus; and
determining a state of the apparatus, using the acquired apparatus data and reference data corresponding to a reference state of the apparatus to be managed.

16. A non-transitory computer-readable medium including programmed instructions that cause a management system configured to manage an apparatus configured to perform a modeling process for generating a three-dimensional modeled object, to execute:
acquiring apparatus data on an operation of the apparatus; and
determining a state of the apparatus, using the acquired apparatus data and reference data corresponding to a reference state of the apparatus to be managed.
